(19) United States
(12) Patent Application Publication
(10) Pub. No.: US 2025/0210699 A1
(43) Pub. Date: Jun. 26, 2025

(54) SOLID ELECTROLYTE MATERIAL WITH HIGH THERMAL STABILITY

(71) Applicant: Solid Power Operating, Inc., Louisville, CO (US)

(72) Inventors: Brian E. FRANCISCO, Arvada, CO (US); Benjamin A. CARLSON, St. Paul, MN (US)

(21) Appl. No.: 19/000,157

(22) Filed: Dec. 23, 2024

Related U.S. Application Data
(60) Provisional application No. 63/614,277, filed on Dec. 22, 2023.

(51) Int. Cl. H01M 10/0562

(52) U.S. Cl. CPC H01M 10/0562; H01M 2300/008

(57) ABSTRACT

A sulfide electrolyte having a P chemical building block, a solid-state battery containing the sulfide electrolyte having a P chemical building block, and a method of making the same. The sulfide electrolyte having a P chemical building block contains at least lithium (Li), sulfur(S), phosphorus (P), and a halogen, and has a structure characterized by an 86.6 ppm ³¹P shift in a ³¹P NMR spectra. In some preferred embodiments, the sulfide electrolyte having a P chemical building block may include chlorine, present in a unique PS₄³⁻—Cl⁻ chemical building block.

### CROSS-REFERENCE TO RELATED APPLICATION

This application is related to and claims priority under 35 U.S.C. § 119 (e) to U.S. Patent Application No. 63/614,277 filed Dec. 22, 2023, titled “SOLID ELECTROLYTE MATERIAL WITH HIGH THERMAL STABILITY,” the entire contents of which is incorporated herein by reference for all purposes.

### FIELD OF THE DISCLOSURE

The present disclosure is directed toward solid electrolyte materials and electrochemical cells containing the solid electrolyte materials, and methods of making the solid electrolyte materials. Therefore, the disclosure relates to the fields of batteries, including solid-state batteries, electronics, chemistry, and materials science.

### BACKGROUND AND INTRODUCTION

Li-ion batteries traditionally use liquid electrolytes, which, being made of flammable organic solvents, may pose safety concerns. With increasing demand for higher capacity, and better overall performance batteries, institutions have turned to solid-state batteries to meet the growing need, while avoiding the safety issues associated with conventional liquid electrolyte cells. A significant factor influencing the performance of solid-state batteries is the type of solid electrolyte materials used. For example, in comparison to conventional liquid electrolytes, solid electrolytes may have challenges related to ionic conductivity. Solid electrolyte materials may also have challenges in achieving ideal contact with the active materials in the positive and negative electrode layers as well as with the electrolyte layer. Therefore, there is ongoing interest in developing solid electrolyte materials which are comparable or even superior to liquid electrolytes in terms of electrical and thermal properties. In pursuit of this goal, there is a growing demand for new solid-state electrolyte materials with unique properties.

The development of new solid state electrolyte materials having new and unique properties has proven to be a challenging endeavor—especially the development of those that are thermally stable. Materials such as the Li₇P₃S₁₁ electrolyte have a P₂S₇⁻⁴ chemical building block but may have low thermal stability in some instances. At high temperatures, electrolyte materials decompose into the most thermodynamically stable materials. These materials are typically composed of P₂S₆⁻⁴ and PS₄⁻³ chemical building blocks such as those having an argyrodite structure expressed by the formula Li⁺₍₁₂₋ₙ₋ₓ₎Bⁿ⁺X²⁻₆₋ₓY⁻ₓ. While the argyrodite materials exhibit high ionic conductivities in comparison to other solid electrolytes, which may be comparable to liquid electrolytes, the development has stalled due to the limitations of the argyrodite structure. For example, the high material hardness of the argyrodite structure may inhibit good contact between the solid electrolyte material and the active materials of a battery. Therefore, there is great need for electrolytes with unique chemical building blocks, among other needs.

It is with these observations in mind, among others, that aspects of the present disclosure were conceived.

### BRIEF SUMMARY

Disclosed herein is a solid-state electrolyte material including lithium (Li), phosphorus (P), sulfur(S), and a halogen, and having a structure characterized by the presence of an 86.6 ppm ³¹P shift in a ³¹P NMR spectra. In some embodiments, the structure may be further defined by the presence of a peak at 9.0 ppm in a ³⁵Cl NMR spectra. In additional embodiments, the structure may be further defined by the presence of a peak at 0.9 ppm in a ⁷Li NMR spectra.

Further disclosed is a solid-state battery including a positive electrode layer, a negative electrode layer, and a separator layer, wherein at least one of the positive electrode layer, the negative electrode layer, and the separator layer includes the above-described solid-state electrode material.

Additionally provided is a method of manufacturing a solid-state electrolyte material, the method including: combining a lithium precursor, a sulfur precursor, a phosphorus precursor, and a halogen precursor with a solvent to form a mixture; milling the mixture to form an amorphous mixture; drying the amorphous mixture at a drying temperature of within a range of about 50° C. to about 150° C. to produce a dry powder; performing a heat treatment by heating the dry powder to a heat treatment temperature within a range of about 200° C. to about 300° C. and maintaining the dry powder at the heat treatment temperature for about 30 minutes to about 120 minutes, to form a solid-state electrolyte material having a structure characterized by the presence of an 86.6 ppm ³¹P shift in a ³¹P NMR spectra.

### BRIEF DESCRIPTION OF THE FIGURES

The present disclosure may be understood by reference to the following detailed description taken in conjunction with the drawings briefly described below. It is noted that, for purposes of illustrative clarity, certain elements in the drawings may not be drawn to scale.

FIG. 1A shows a comparison of ⁷Li NMR spectra for Example 1 and Comparative Examples 1-2.

FIG. 1B shows a comparison of ³¹P NMR spectra for Example 1 and Comparative Examples 1-2.

FIG. 1C shows a comparison of ³⁵Cl NMR data for Comparative Example 1 (as-milled), Example 1 (240° C.), and Solid LiCl.

### DETAILED DESCRIPTION

Before various aspects of the present invention are disclosed and described, it is to be understood that this invention is not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity and in another example, a numerical range of “about 50 mg/mL to about 80 mg/mL” should also be understood to provide support for the range of “50 mg/mL to 80 mg/mL.”

In this disclosure, the terms “including,” “containing,” and/or “having” are understood to mean comprising, and are open ended terms.

The indefinite articles “a” and “an,” as used herein in the specification and in the claims, unless clearly indicated to the contrary, should be understood to mean “at least one.”

As used herein, the term “electrolyte” refers to a complete material suitable for use as the electrolyte in an electrochemical device. A “solid electrolyte” refers to an electrolyte in the solid state, which is suitable for use in the same state. The solid electrolyte or electrolyte may be a pure, i.e., a single component material, with respect to both chemical composition, crystalline structure, and atomic structure, or it may contain a mixture of components having different chemical compositions, crystalline structures, and/or atomic structures.

As used herein, the term “composite” refers to a mixture of at least two components having distinct chemical compositions, crystalline structures, and/or atomic structures.

As used herein, the term “compound” refers to a component defined by a single chemical composition and a single crystalline structure.

As used herein, the term “sulfide electrolyte having a P chemical building block” refers to a sulfide solid electrolyte having a structure defined by an 86.6 ppm ³¹P shift in a ³¹P NMR spectra. More specifically, the sulfide electrolyte having a P (phosphorus) chemical building block includes a phosphorus atom within its crystalline structure, with surrounding atoms (e.g., Li, S, and Cl) having a specific arrangement which causes unique behavior of the electrons of the P atom-resulting in an 86.6 ppm ³¹P shift in a ³¹P NMR spectra.

The present application presents a sulfide electrolyte having a P chemical building block which has high thermal stability, a solid-state battery including the sulfide electrolyte having a P chemical building block, and methods of making the same. The sulfide electrolyte having a P chemical building block comprises at least lithium (Li), phosphorus (P), sulfur(S), and a halogen, but has a unique architecture at the atomic level, which can be identified in various NMR Spectra. Specifically, the sulfide electrolyte having a P chemical building block has a structure which can be defined by an 86.6 ppm ³¹P shift in a ³¹P NMR spectra. This compound, with a unique atomic level structure, can be utilized in the positive electrode layer, negative electrode layer, and separator layer of a solid-state battery.

The sulfide electrolyte having a P chemical building block of the present disclosure comprises at least lithium (Li), phosphorus (P), sulfur(S), and a halogen. In a preferred embodiment, the sulfide electrolyte having a P chemical building block comprises at least lithium (Li), phosphorus (P), sulfur(S), and chlorine (C1). In some embodiments, the sulfide electrolyte having a P chemical building block may further comprise additives or dopants, such as one or more of Si, Sn, Ge, Sb, or O.

In some embodiments, the sulfide electrolyte having a P chemical building block may comprise lithium and PS₄⁻³Cl⁻, having a unique structure identifiable in ³¹P NMR. Specifically, the sulfide electrolyte having a P chemical building block has a structure characterized by an 86.6 ppm ³¹P shift in a ³¹P NMR spectra. This peak at 86.6 ppm in a ³¹P NMR spectra is indicative of the atomic level structure of the sulfide electrolyte having a P chemical building block, which is built on a unique PS₄³⁻—Cl⁻ chemical building block. The Li atoms of the electrolyte may also have a 0.9 ppm ⁷Li shift in the ⁷Li NMR spectra which corresponds to the presence of Li in a unique chemical environment. Additionally, in a preferred embodiment, the Cl atoms in the sulfide electrolyte having a P chemical building block may have a 9.0 ppm ³⁵Cl shift in the ³⁵Cl NMR spectra, indicating that the electrolyte contains Cl in a unique chemical environment.

In some embodiments, the sulfide electrolyte having a P chemical building block may be in the form of a nanocomposite comprise lithium and PS₄⁻³Cl⁻, having a unique structure identifiable in ³¹P NMR, where a nanocomposite contains one or more materials having particles with a particle size less than 1 micron.

In some aspects, the sulfide electrolyte having a P chemical building block may be used alone, in pure or substantially pure form. That is, the present disclosure includes a solid electrolyte containing the sulfide electrolyte having a P chemical building block in an amount of 95 wt % or more, 99 wt % or more, or 100 wt %, based on a total weight of the solid electrolyte present in a battery cell.

In other aspects, the sulfide electrolyte having a P chemical building block may form only a part or a portion of a total amount solid electrolyte contained in a battery cell. In other embodiments, the sulfide electrolyte having a P chemical building block may be included as a composite with other solid electrolyte compounds. In still other embodiments, the sulfide electrolyte having a P chemical building block may be modified by the addition of dopants, additives, or additional elements. For example, one or more of Si, Sn, Ge, Sb, or O may be added to the sulfide electrolyte having a P chemical building block.

In such embodiments, the sulfide electrolyte having a P chemical building block may be present in an amount of greater than 0 wt % to less than 100 wt %, based on a total weight of a solid electrolyte present in a battery cell. More specifically, the sulfide electrolyte having a P chemical building block may be present in an amount of about 0.1 wt % to about 2.5 wt %, about 0.5 wt % to about 3 wt %, about 1 wt % to about 5 wt %, or about 2.5 at % to about 7.5 wt %.

The sulfide electrolyte having a P chemical building block of the present disclosure may be included in a solid-state battery. More specifically, the sulfide electrolyte having a P chemical building block of the present disclosure may be present in one or more of the positive electrode layer, the negative electrode layer, and/or the separator layer of a solid-state battery. In a solid-state battery containing the sulfide electrolyte having a P chemical building block, NMR data of a sample of the positive electrode layer, the negative electrode layer, and/or the separator layer will include at least one of an 86.6 ppm ³¹P shift in a ³¹P NMR spectra, a peak at 9.0 ppm in a ³⁵Cl NMR spectra, and/or a peak at 0.9 ppm in a ⁷Li NMR spectra.

Formation of the sulfide electrolyte having a P chemical building block is highly process sensitive and may be affected by, e.g., the identity and amounts of starting materials, times, temperatures, and pressures used, and the interactions between these process parameters. However, a generalized method for preparing the sulfide electrolyte having a P chemical building block involves combining starting materials in the presence of a solvent to form a mixture, milling the mixture to form an amorphous mixture, drying amorphous mixture to remove the solvent and form an amorphous powder, performing a heat treatment on the amorphous powder to form the crystallized sulfide electrolyte containing a PS₄⁻³Cl⁻ chemical building block. Alternatively, the sulfide electrolyte having a P chemical building block may be prepared by a dry process, including combining the starting materials to form a dry mixture without solvent, milling the dry mixture to form an amorphous mixture, crystallizing the amorphous material to form a crystalline powder-having the PS₄⁻³Cl⁻ chemical building block. The sulfide electrolyte having a P chemical building block may be present in pure or substantially pure form, or may be present in a mixture or composite, depending on the precise process conditions used. The sulfide electrolyte having a P chemical building block may be found in the form of dried powder and is identifiable as an 88 ppm ³¹P shift in a ³¹P NMR spectra, whether in a mixture or in pure form.

The starting materials used in this process may include a lithium precursor, a phosphorus precursor, a sulfur precursor, and a halogen precursor. Optionally, the starting materials may include one or more dopant precursors containing at least one of Si, Sn, Ge, Sb, or O. The lithium precursor may include one or more of LiCl, Li₂S, LiBr, or LiI. The phosphorus precursor includes P₂S₅. The sulfur precursor may include one or more of Li₂S or elemental sulfur. The halogen precursor may include one or more of LiCl, LiBr, or LiI. In a preferred embodiment, the halogen precursor contains Cl. Thus, a preferred species of halogen precursor is LiCl. In some cases, a single species may serve as two or more of the aforementioned precursors when the species contains the relevant elements. For example, Li₂S may serve in the role of both the sulfur precursor and the lithium precursor, since it contains both lithium and sulfur. Preferably, the precursor materials are mixed in stoichiometric amounts. If the precursor materials are mixed in inappropriate amounts (e.g., non-stoichiometric amounts) the sulfide electrolyte having a P chemical building block may not be formed.

In some embodiments, the starting materials may be combined in the presence of an organic solvent, such as (but not limited to) acetone, ethyl acetate, hexane, heptane, dichloromethane, methanol, ethanol, tetrahydrofuran, acetonitrile, dimethylformamide, toluene, dimethylsulfoxide, xylenes, or mixtures thereof. In a preferred embodiment, the solvent includes xylenes. In alternative embodiments, the starting materials may be combined to form a dry mixture.

The mixture of the starting materials (either wet or dry) may then be milled, e.g. using a milling jar, for a sufficient amount of time to achieve a homogeneous, amorphous mixture. Alternatively, the mixture of starting materials may be mixed using one or more of grinding, tumbling, or shaking methods. For example, the mixture may be milled or otherwise mixed for a time period of 1 minute to 36 hours, preferably 1 hour to 24 hours, more preferably 3 hours to 18 hours, or most preferably 6 hours to 12 hours.

After mixing, the amorphous mixture formed by the mixing process may be subjected to a drying process to remove the solvent. The drying process may be performed using any suitable apparatus for applying heat, convection, vacuum, or the like. For example, the drying process may be performed in a vacuum oven. The drying process may be performed at a temperature within the range of about 50° C. to about 150° C., preferably within the range of about 60° C. to about 140° C., and more preferably within the range of about 70° C. to about 130° C. Drying may be conducted for about 30 minutes to about 8 hours, about 1 hour to about 6 hours, or about 2 hours to about 5 hours, with the appropriate drying time being dependent on the temperature used and the type and specification of the drying apparatus used. The drying process results in a dry amorphous powder. In an embodiment in which a solvent is not used, the amorphous mixture may be heated, without a drying step, in order to produce a crystalline powder comprising the sulfide electrolyte having a P chemical building block

The dried mixed powder is then subjected to a heat treatment process. The heat treatment may be performed using any suitable apparatus for applying heat. During the heat treatment, temperature of the dry amorphous powder may be heated to a heat treatment temperature within the range of about 200° C. to about 300° C., preferably within the range of about 220° C. to about 290° C., and more preferably within the range of about 230° C. to about 280° C. The powder may be maintained at the heat treatment temperature for about 30 minutes to about 8 hours, about 1 hour to about 6 hours, or about 2 hours to about 5 hours with the appropriate times and temperatures being dependent on each other, as well as on the identity and content of the precursor materials used. When the correct conditions are applied, the heat treatment produces the crystalline solid electrolyte.

### EXAMPLES

Examples have been set forth below for the purpose of illustration and to describe certain specific embodiments of the disclosure. However, the scope of the claims is not to be in any way limited by the examples set forth herein. Various changes and modifications to the disclosed embodiments will be apparent to those skilled in the art and such changes and modifications including, without limitation, those relating to the chemical structures, substituents, derivatives, formulations, or methods of the disclosure may be made without departing from the spirit of the disclosure and the scope of the appended claims. Definitions of the variables in the structures in the schemes herein are commensurate with those of corresponding positions in the formulae presented herein.

### Comparative Example 1

2.63 g of LiCl, 8.55 g of Li₂S, and 13.82 g of P₂S₅ were placed in a mill jar with media (5 mm ceramic balls) and Xylenes. The precursors were milled for 12 hours. After which, the solvent was removed by placing the milling jar containing the milled material in a vacuum oven where the material was heated to 70° C. for 60 minutes while under vacuum conditions. The resulting material was an amorphous dried powder.

### Example 1

An aliquot of the dried material from Comparative Example 1 was then heated to 240° C. for one hour to form the crystallized electrolyte of Example 1.

### Comparative Example 2

Comparative Example 2 followed the same process as Example 1, except that 5.6 g of Li₂S and 15.44 g of P₂S₅ were used as starting materials, and LiCl was not used.

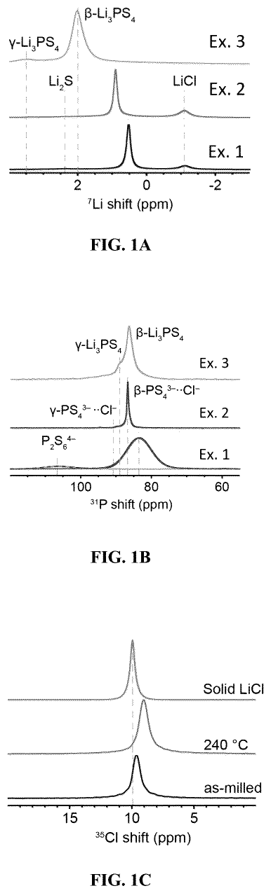

Applicants collected the ⁷Li NMR spectra data for the material produced in Example 1 and Comparative Examples 1-2, which is shown in FIG. 1A. The ⁷Li NMR spectra data for Comparative Example 1 showed peaks at-1.1 ppm and at 0.61 ppm. The ⁷Li NMR spectra data for Example 1 showed peaks at-1.1 ppm and 0.9 ppm. The ⁷Li NMR spectra data for Comparative Example 2 showed a peak at 2.0 ppm.

The ⁷Li NMR spectra data for the material of Example 1 showed a peak observed at 0.9 ppm which corresponds to the presence of Li in a unique chemical environment and showed the absence of a peak at 2 ppm which would correspond to the presence of β-Li₃PS₄. The ⁷Li NMR spectra data for the material of Comparative Example 2 did not have a peak at 0.9 ppm but did have a peak at 2 ppm. This suggests that, for the material of Example 1, the lithium ions reside in lattice sites that are unique compared to the β-Li₃PS₄ material of Comparative Example 2.

Applicant also collected ³¹P NMR spectra data for the material produced in Example 1 and Comparative Examples 1-2, which is shown in FIG. 1B. The ³¹P NMR spectra data for the material produced in Comparative Example 1 showed peaks at 83.5 ppm and 106.4 ppm. The ³¹P NMR spectra data for the material produced in Example 1 showed a peak at 86.6 ppm. The ³¹P NMR spectra data for the material produced in Comparative Example 2 showed peaks at 82.2 ppm and at 88 ppm.

The ³¹P NMR spectra data for the material of Example 1 showed a peak observed at 86.6 ppm which corresponds to the presence of the sulfide electrolyte containing a unique PS₄³⁻—Cl⁻ chemical building block. The ³¹P NMR spectra data for the material of Comparative Example 2 showed a peak at 86.4 ppm which was broadened compared to the peak at 86.6 ppm in Example 1, and the material of Comparative Example 2 had an additional peak at 88 ppm which corresponds to a typical chemical building block found in γ-Li₃PS₄. When considering the shift and broadness of peaks in Example 1 compared to Comparative Example 2, and examining the ³⁵Cl and ⁷Li spectra simultaneously, it can be understood that the peak in Example 1 represents a unique chemical environment for phosphorus compared to Comparative Examples 1 and 2.

Applicant gathered the ³⁵Cl NMR spectra data for the materials produced in Comparative Example 1 and Example 1, as well as for solid LiCl, as shown in FIG. 1C. The ³⁵Cl NMR spectra data for the material produced in Comparative Example 1, shown in FIG. 1C, had a peak at 9.75 ppm. The ³⁵Cl NMR spectra data for the material produced in Example 1, shown in FIG. 1C, had a peak at 9 ppm. The ³⁵Cl NMR spectra data for the solid LiCl, shown in FIG. 1C, had a peak at 9.99 ppm. These results can be understood as demonstrating that the material of Example 1 contains Cl in a unique chemical environment.

The examples-in particular the comparison of NMR data from Examples with NMR data of Comparative Examples 1-2-demonstrates the production of a sulfide electrolyte that has a PS₄³⁻—Cl⁻ chemical building block having a unique structure at the atomic level. The presence of the sulfide electrolyte having a P chemical building block and its unique architecture was evidenced by the combination of ³¹P NMR data, ³⁵Cl NMR data and ⁶Li NMR data. Surprisingly, the sulfide electrolyte having a P chemical building block had characteristic peaks in solid-state NMR spectra indicating a structure comprising PS₄³⁻ anions, halogen anions, and lithium cations contained within the same crystal structure or nanocomposite and with signatures different from other reference materials. The arrangement of chemical building blocks or ionic units is such that long range ordering of PS₄³⁻ anions is similar to that found in β-Li₃PS₄. However, the halogen anions may be contained within the structure in close proximity to PS⁻⁴ anions, as evidenced by a slight shift in ³¹P NMR peak and ³⁵Cl NMR peak when comparing to β-Li₃PS₄ and LiCl reference materials, respectively. Additionally, the ⁶Li NMR data of this new solid electrolyte material suggests the absence of a β-Li₃PS₄ by the lack of a 2 ppm shift in the material's spectra.

What is claimed:

1. A solid-state electrolyte material comprising lithium (Li), phosphorus (P), sulfur(S), and a halogen, and having a structure characterized by the presence of an 86.6 ppm ³¹P shift in a ³¹P NMR spectra.

2. The solid-state electrolyte material of claim 1, further comprising chlorine (Cl), wherein the structure is further defined by the presence of a peak at 9.0 ppm in a ³⁵Cl NMR spectra.

3. The solid-state electrolyte material of claim 1, wherein the structure is further defined by the presence of a peak at 0.9 ppm in a ⁷Li NMR spectra.

4. The solid-state electrolyte material of claim 1, wherein the halogen includes chlorine.

5. The solid-state electrolyte material of claim 1, wherein the solid-state electrolyte material comprises PS₄³⁻—Cl⁻.

6. The solid-state electrolyte material of claim 1, further comprising a dopant comprising one or more of one or more of Si, Sn, Ge, Sb, or O.

7. A solid-state battery comprising a positive electrode layer, a negative electrode layer, and a separator layer,
wherein at least one of the positive electrode layer, the negative electrode layer, and the separator layer include the solid-state electrolyte material of claim 1.

8. A method of manufacturing a solid-state electrolyte material, the method comprising:
combining a lithium precursor, a sulfur precursor, a phosphorus precursor, and a halogen precursor with a solvent to form a mixture,
milling the mixture to form an amorphous mixture,
drying the amorphous mixture at a drying temperature of within a range of about 50° C. to about 150° C. to produce a dry powder,
performing a heat treatment by heating the dry powder to a heat treatment temperature within a range of about 200° C. to about 300° C. and maintaining the dry powder at the heat treatment temperature for about 30 minutes to about 120 minutes, to form a solid-state electrolyte material having a structure characterized by the presence of an 86.6 ppm ³¹P shift in a ³¹P NMR spectra.

9. The method of claim 8, wherein the heat treatment temperature is within a range of about 220° C. to about 290° C.

10. The method of claim 8, wherein the heat treatment temperature is within a range of about 230° C. to about 280° C.

11. The method of claim 8, wherein the drying temperature is within a range of about 60° C. to about 140° C.

12. The method of claim 8, wherein the drying temperature is within a range of about 70° C. to about 130° C.

13. The method of claim 8, further comprising combining a dopant precursor comprising one or more of one or more of Si, Sn, Ge, Sb, or O, with the lithium precursor, the sulfur precursor, the phosphorus precursor, and the halogen precursor.

14. The method of claim 8, wherein the lithium precursor comprises one or more of LiCl, Li₂S, LiBr, or LiI.

15. The method of claim 8, wherein the phosphorus precursor comprises P₂S₅.

16. The method of claim 8, wherein the sulfur precursor comprises one or more of Li₂S or elemental sulfur.

17. The method of claim 8, wherein the halogen precursor comprises one or more of LiCl, LiBr, or LiI.

18. The method of claim 17, wherein the halogen precursor comprises LiCl.
